(19) United States
(12) Patent Application Publication
(10) Pub. No.: US 2016/0085385 A1
(43) Pub. Date: Mar. 24, 2016

(54) AN APPARATUS AND ASSOCIATED METHODS

(71) Applicant: NOKIA TECHNOLOGIES OY, Espoo (FI)

(72) Inventors: Bin GAO, Beijing (CN); Yunjian ZOU, Beijing (CN)

(73) Assignee: Nokia Technologies Oy, Espoo (FI)

(21) Appl. No.: 14/889,597

(22) PCT Filed: May 8, 2013
(86) PCT No.: PCT/CN2013/075298

§ 371 Date: Nov. 6, 2015

(51) Int. Cl. G06F 3/0481; H04M 1/725

(52) U.S. Cl. CPC G06F 3/0481; H04M 1/72583

(57) ABSTRACT

An apparatus, the apparatus comprising at least one processor, and at least one memory including computer program code, the at least one memory and the computer program code configured, with the at least one processor, to cause the apparatus to perform at least the following: provide at least one application in an application set for user activation, the inclusion of the at least one application in the application set based on time-dependent functionality of the at least one application.

### TECHNICAL FIELD

The present disclosure relates to user interfaces and electronic devices, associated methods, computer programs and apparatus.

### BACKGROUND

Some electronic devices can be used to run applications. Certain applications may provide certain features for a predefined period of time and certain applications may provide certain features for an unlimited period of time.

The listing or discussion of a prior-published document or any background in this specification should not necessarily be taken as an acknowledgement that the document or background is part of the state of the art or is common general knowledge. One or more embodiments of the present disclosure may or may not address one or more of the background issues.

### SUMMARY

In a first example embodiment there is provided an apparatus comprising at least one processor and at least one memory including computer program code, the at least one memory and the computer program code configured to, with the at least one processor, cause the apparatus to perform at least the following: provide at least one application in an application set for user activation, the inclusion of the at least one application in the application set based on time-dependent functionality of the at least one application. Without limiting the scope of the claims, an advantage of providing applications having time-dependent functionality for user activation in a set of such applications may be to improve application management, and may be to allow for improved use of the time-limited functionality of such applications. Another advantage of a collation of applications having time-dependent functionality in an automatically updated set for user-activation may be that the user can easily open applications in which functionality may soon cease to ensure they get use of the time dependent and, for example, time-limited, functionality. The collation of applications having time-dependent functionality comprises the grouping together of such applications, for example so that they may be handled/treated in a particular way, such as displaying an icon or icons for the collated applications to a user on a home screen or locked screen.

The apparatus may be configured to provide for the automatic identification of the at least one application having time dependent functionality for inclusion in the application set. The apparatus may form the application set from the at least one identified application based on time-dependent functionality of the at least one identified application.

The apparatus may be configured to differentiate between applications having time-dependent functionality which are included in the application set, and applications that do not have time dependent functionality which are outside the application set.

The apparatus may be configured to display a graphical user interface element representing a particular application in the application set on a display. In some examples the graphical user interface element may be an icon, widget or banner on a homescreen or a locked screen of a device. In some examples the graphical user interface element may be an option or entry in a list or menu. In some examples the graphical user interface element may be considered to be an element (e.g. an icon or a list entry) associated with a particular application in the application set. In some examples the graphical user interface element may be considered to be an element associated with a plurality of the applications in the application set (e.g., a portion of a menu or a selection or grid of icons/tiles).

The apparatus may be configured to allow for actuation of a particular application in the application set by one or more of: user selection of a graphical user interface element associated with the particular application (for example, tapping an application icon on a home screen); detection of a user-provided voice command associated with the particular application (for example, detection by microphone of a user reciting a name for the particular application); and detection of a user gesture associated with a particular application (for example, a user may swipe in a particular direction on a touch sensitive screen to actuate a particular application, or a user may provide a particular deformation input associated with a particular application by bending, squeezing or applying pressure to an input sensor in a way corresponding to actuation of the particular application). Actuation of a particular application may be opening the application.

Without limiting the scope of the claims, an advantage of displaying a graphical user interface element representing a particular application in the set of applications having time-dependent functionality, wherein the graphical user interface element may be user-actuated to activate/open the associated application, may be to provide a visual cue to the user that the additional functionality of the application is currently available for use.

The apparatus may be configured to display the graphical user interface element in a locked screen of a display of an electronic device, the electronic device operating in a locked mode. A locked mode may be considered to be an operating mode of the electronic device in which a subset of functionality is available to a user compared with the functionality available to a user when the electronic device is operating in an unlocked mode. For example, in the locked mode, the user may be able to unlock the device and use a music player application, but might not be able to, for example, make telephone calls and/or transmit messages to third parties without first unlocking the device.

Without limiting the scope of the claims, an advantage of providing the graphical user interface element in a locked screen for actuation while the electronic device is operating in a locked mode may be allowing the user to open and use the application including the time-limited functionality directly from the locked screen, without requiring the device to be unlocked and without requiring the user to navigate a menu system or series of steps to open/activate the application. Alternatively, the apparatus may be configured to receive user-actuation of the graphical user interface element to initiate the opening of the associated application and then prompt the user to unlock the apparatus before directly providing the selected application for use once the device has been unlocked, by entering a password or code, for example. This may allow for a readily accessible and intuitive way of allowing a user to use applications while time-dependent or time-limited functionality is available. This may enhance the user experience of the application.

The apparatus may be configured to display the graphical user interface element in a homescreen of a display of an electronic device. The homescreen may be available while the electronic device is operating in a locked mode in some examples. The homescreen may be available while the electronic device is operating in an unlocked mode in some examples. Similarly, the user is provided with a visual cue and a simple way of activating the application without requiring any menu navigation or similar while the time-limited functions of the application are available for use.

The apparatus may be configured to, based on a received user input associated with the displayed graphical user interface element of a particular application in the application set, launch the particular application.

The time-dependent functionality of the at least one application may be one or more of:
particular functionality of a particular application in the application set available for a predetermined period of time from the time at which the particular application was made available for use;
particular functionality of a particular application in the application set available for a predetermined period of time from the time at which that particular functionality was made available for use; and
particular functionality of a particular application available for a predetermined period of time between predetermined start and end times.

Thus, for example, an application that has time dependent functionality, such that the application is able to perform a particular function over a particular limited time period, can be included in the application set for user actuation. Applications that do not have functionality that is available for use at particular limited times may not be included in the application set. This may provide easy access to applications that can perform particular functions at particular times.

The apparatus may be configured to provide for the inclusion of a particular application in the application set based on currently available time-dependent functionality of the particular application.

An example of particular functionality being available for a predetermined period of time from the time at which the particular application, or particular functionality, was made available for use is the use of an application, or certain features of an application, for a trial period. For example, a music application may be used to download music for free within one year from installation of the application. After the year, the user may be able to use the music application but may be required to pay for any music downloads made after the initial year's use period. As another example, a full version of an application (allowing use of all the features of the application) may be available for use within one month of installing the application. After that month, the user may be allowed to use a version with limited features compared with the full version, or may not be able to use the application at all, unless the user pays a fee, for example.

An example of particular functionality being available for a predetermined period of time between predetermined start and end times is the availability of seasonal applications or applications with seasonal features. For example, a user may be able to access “Christmas themed” levels of a particular game application from 1^{st} to 31^{st} December, but the levels may not be available to play outside this December period. As another example, an e-book store may allow e-books to be purchased at a discounted price during a predefined “national reading week”, and outside this predefined week, the books may be purchased at full price. In some examples, the particular functionality of an application may be all functionality of the application. For example, a guide/map application for a holiday park may be available for use in limited periods in which the application is registered as being associated with the holiday park (for example, for a pre-booked holiday period of one week). The application may not be available for use outside this pre-booked holiday time period. This may also be considered an example of the application being part of the set of applications having time limited functionality based on currently available functionality. As an example of varying levels of functionality being available within an application for a limited period of time, an astronomy application for identifying celestial bodies in the night sky can identify celestial bodies at the times when they are visible from the user's location. Thus, the application may be included in the application set at times when celestial bodies identifiable by the application are visible to the user.

The apparatus may be configured to provide for the removal of a particular application from the application set based on the expiry of time-dependent functionality of the particular application.

For example, a music store/player application may allow music to be downloaded for free for six months after the registration of a device on which the application is installed. During that six month period when free music downloads are available, the apparatus may provide for the inclusion of the music store/player application in the set of applications with time-dependent functionality. After this six-month period the apparatus may provide for the music store/player application to be removed from the application set because there is no time-dependent functionality available anymore.

Advantageously the user can be provided with an automatically managed set of applications for which time-limited functionality is currently available in a timely and relevant way. Also, the amount of redundant information in the set of applications may be reduced by automatically removing applications from the set when the time-limited functionality of those applications expires or is not currently available.

The apparatus may be configured to provide for the removal of a displayed graphical user interface element associated with the particular application from a display of an electronic device. In some examples the electronic device may be operating in a locked mode and the display screen may be a locked display screen. In some examples the display screen may be a home screen, and the device may or may not be operating in a locked mode.

For example, taking the example of the music store/player application discussed above, during the six month period when the application allows free music downloads, an icon associated with the application may be provided on a homescreen of an electronic device. After the expiry of the six month period, the apparatus may provide for the icon to be removed from display. The icon may be removed from the homescreen but may be available on another (for example, less frequently used) screen or in a menu, for example. In some examples the apparatus may provide for the application, or parts of the application, to be uninstalled or otherwise made unavailable for use after the expiry of the time-dependent functionality.

Applications which have expired or for which certain functionality has expired may therefore be automatically removed from presentation to the user on a homescreen or locked screen. Thus advantageously, the homescreen and/or locked screen of the device does not present information about applications which have expired or for which certain time limited functionality has expired, and therefore presents relevant information about applications having currently available time-limited functionality.

The apparatus may be configured to provide one or more applications in the application set for user activation by storing a list of the one or more applications. For example, the apparatus may be configured to maintain, or to access a maintained list of applications having time-limited functionality. The list may contain details of applications with currently available time-limited functionality, of applications which have in the past provided time-limited functionality, and/or applications which may in the future provide time-limited functionality. Thus, an up to date record of applications for which time-limited functionality was, is, or will be available can be maintained and used to improve management of information provided to the user about expired, currently available, or upcoming functionality.

The apparatus may be configured to provide for the inclusion of a particular application in the application set based on one or more of:
the apparatus receiving information from the particular application that the particular application has time-dependent functionality;
the apparatus determining that the particular application has time-dependent functionality; and
the apparatus receiving information from a third party that the particular application has time-dependent functionality.

For example, the apparatus may receive information on time-limited functionality of an application upon download/installation of the application from the application provider, and receipt of the information may cause the apparatus to provide for that application to be included in the set of applications with time-limited functionality. As another example, the apparatus may receive information on time-limited functionality of an application upon download/installation of the application from the application provider, and the apparatus may scan, or cause another apparatus to scan the received application for information regarding time-limited functionality. As another example, the apparatus may receive information on time-limited functionality of an application upon download/installation of the application from an entity which is not the application provider, such as a third party application developer, promoter or associated entity. Examples of such a third party are a publisher associated with e-books accessible using an e-book application, and a game level/feature developer providing features for a game/application developed by another party. The apparatus may be considered to provide for the identification of the at least one application for inclusion in the application set by, for example receiving information about the application time-dependence, and/or by the apparatus actively scanning an application for time-dependent functionality.

The apparatus may be configured to provide an indication of the remaining time available for use of the time-dependent functionality of a particular application in the application set.

For example, the apparatus may cause a note to be displayed to a user during the final week or other period of availability of an application or features of an application. This may help the user manage his or her use of such applications more effectively.

The apparatus may be configured such that the application set is a time-dependent application set which is limited to include applications having time-dependent functionality. Thus the application set may only include applications having time-dependent functionality and may exclude applications which do not have time-dependent functionality. It may be that applications are included when time-dependent functionality is currently available and/or removed from the application set when the time-limited functionality expires.

The apparatus may be one or more of: a portable electronic device, a mobile phone, a smartphone, a tablet computer, a surface computer, a laptop computer, a personal digital assistant, a graphics tablet, a pen-based computer, a digital camera, a watch, a non-portable electronic device, a desktop computer, a monitor/display, a household appliance, a refrigerator, a cooker, a cooling/heating system, a server, or a module for one or more of the same.

According to a further example embodiment, there is provided a computer program comprising computer program code, the computer program code being configured to perform at least the following: provide at least one application in an application set for user activation, the inclusion of the at least one application in the application set based on time-dependent functionality of the at least one application.

According to a further example embodiment, there is provided a method, the method comprising: providing at least one application in an application set for user activation, the inclusion of the at least one application in said the application set based on time-dependent functionality of the at least one application.

According to a further example embodiment there is provided an apparatus comprising: means for providing at least one application in an application set for user activation, the inclusion of the at least one application in the application set based on time-dependent functionality of the at least one application.

The present disclosure includes one or more corresponding aspects, embodiments or features in isolation or in various combinations whether or not specifically stated (including claimed) in that combination or in isolation. Corresponding means and corresponding function units (e.g., includer for including applications in the application set, time-dependent functionality determiner, graphical user interface element displayer) for performing one or more of the discussed functions are also within the present disclosure.

A computer program may be stored on a storage media (e.g. on a CD, a DVD, a memory stick or other non-transitory medium). A computer program may be configured to run on a device or apparatus as an application. An application may be run by a device or apparatus via an operating system. A computer program may form part of a computer program product. Corresponding computer programs for implementing one or more of the methods disclosed are also within the present disclosure and encompassed by one or more of the described embodiments.

The above summary is intended to merely relate to examples and be non-limiting.

### BRIEF DESCRIPTION OF THE FIGURES

A description is now given, by way of example, with reference to the accompanying drawings, in which:

FIG. 1 illustrates an example apparatus embodiment comprising a number of electronic components, including memory and a processor, according to one embodiment of the present disclosure;

FIG. 2 illustrates an example apparatus embodiment comprising a number of electronic components, including memory, a processor and a communication unit, according to another embodiment of the present disclosure;

FIG. 3 illustrates an example apparatus embodiment comprising a number of electronic components, including memory and a processor, according to another embodiment of the present disclosure;

FIGS. 4a-4b illustrate a device with a locked screen displaying an icon representing an application with time-dependent functionality according to embodiments of the present disclosure;

FIGS. 5a-5d illustrate a device downloading an application with time-dependent functionality, and a user interacting with an icon for that application in a locked screen of the device according to embodiments of the present disclosure;

FIG. 6 illustrates a device with a locked screen displaying a menu, each item in the menu representing an application in a set of applications having time-dependent functionality according to embodiments of the present disclosure;

FIGS. 7a-7b illustrate a home screen of a device displaying information relating to an application with time-dependent functionality according to embodiments of the present disclosure;

FIGS. 8a-8c illustrate an apparatus obtaining information about time-dependent functionality of an application according to embodiments of the present disclosure;

FIG. 9 illustrates a list of information of time-limited applications according to embodiments of the present disclosure;

FIGS. 10a-10b each illustrate an apparatus in communication with a remote computing element;

FIG. 11 illustrates a flowchart according to an example method of the present disclosure; and

FIG. 12 illustrates schematically a computer readable medium providing a program.

### DESCRIPTION OF EXAMPLE ASPECTS/EMBODIMENTS

Other embodiments depicted in the figures have been provided with reference numerals that correspond to similar features of earlier described embodiments. For example, feature number 100 can also correspond to numbers 200, 300 etc. These numbered features may appear in the figures but may not have been directly referred to within the description of these particular embodiments. These have still been provided in the figures to aid understanding of the further embodiments, particularly in relation to the features of similar earlier described embodiments.

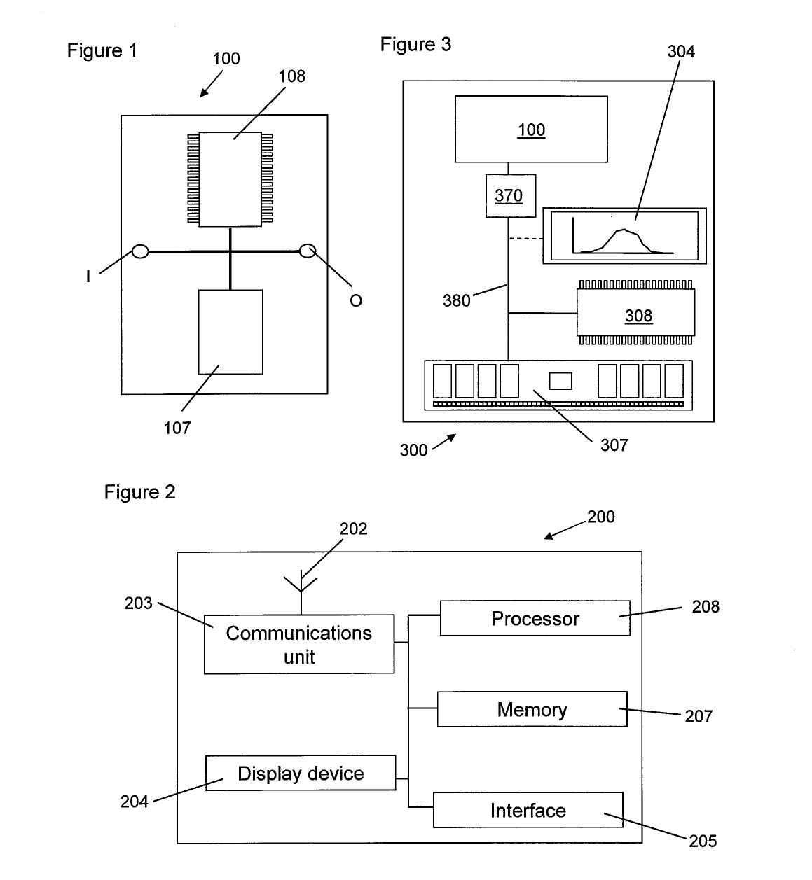

FIG. 1 shows an apparatus 100 comprising memory 107, a processor 108, input I and output O. In this embodiment one processor and one memory are shown but it will be appreciated that other embodiments may utilise more than one processor and/or more than one memory (e.g. same or different processor/memory types).

In this embodiment the apparatus 100 is an Application Specific Integrated Circuit (ASIC) for a portable electronic device with a touch sensitive display. In some embodiments the apparatus 100 can be a module for such a device, or may be the device itself, wherein the processor 108 is a general purpose CPU of the device and the memory 107 is general purpose memory comprised by the device. The display, in some embodiments, may not be touch sensitive.

The input I allows for receipt of signalling to the apparatus 100 from further components, such as components of a portable electronic device (like a touch-sensitive or hover-sensitive display or microphone) or the like. The output O allows for onward provision of signalling from within the apparatus 100 to further components such as a display screen, speaker, or vibration module. In this embodiment the input I and output O are part of a connection bus that allows for connection of the apparatus 100 to further components.

The processor 108 is a general purpose processor dedicated to executing/processing information received via the input I in accordance with instructions stored in the form of computer program code on the memory 107. The output signalling generated by such operations from the processor 108 is provided onwards to further components via the output O.

The memory 107 (not necessarily a single memory unit) is a computer readable medium (solid state memory in this example, but may be other types of memory such as a hard drive, ROM, RAM, Flash or the like) that stores computer program code. This computer program code stores instructions that are executable by the processor 108, when the program code is run on the processor 108. The internal connections between the memory 107 and the processor 108 can be understood to, in one or more example embodiments, provide an active coupling between the processor 108 and the memory 107 to allow the processor 108 to access the computer program code stored on the memory 107.

In this example the input I, output O, processor 108 and memory 107 are all electrically connected to one another internally to allow for electrical communication between the respective components I, O, 107, 108. In this example the components are all located proximate to one another so as to be formed together as an ASIC, in other words, so as to be integrated together as a single chip/circuit that can be installed into an electronic device. In some examples one or more or all of the components may be located separately from one another.

FIG. 2 depicts an apparatus 200 of a further example embodiment, such as a mobile phone. In some example embodiments, the apparatus 200 may comprise a module for a mobile phone (or mobile computing device, PDA or audio/video player, a household appliance such as a refrigerator, or a dashboard in a car), and may just comprise a suitably configured memory 207 and processor 208.

The example embodiment of FIG. 2 comprises a display device 204 such as, for example, a liquid crystal display (LCD), e-Ink or touch-screen user interface. The apparatus 200 of FIG. 2 is configured such that it may receive, include, and/or otherwise access data. For example, this example embodiment 200 comprises a communications unit 203, such as a receiver, transmitter, and/or transceiver, in communication with an antenna 202 for connecting to a wireless network and/or a port (not shown) for accepting a physical connection to a network, such that data may be received via one or more types of networks. This example embodiment comprises a memory 207 that stores data, possibly after being received via antenna 202 or port or after being generated at the user interface 205. The processor 208 may receive data from the user interface 205, from the memory 207, or from the communication unit 203. It will be appreciated that, in certain example embodiments, the display device 204 may incorporate the user interface 205. Regardless of the origin of the data, these data may be outputted to a user of apparatus 200 via the display device 204, and/or any other output devices provided with apparatus. The processor 208 may also store the data for later use in the memory 207. The memory 207 may store computer program code and/or applications which may be used to instruct/enable the processor 208 to perform functions (e.g. read, write, delete, edit or process data).

FIG. 3 depicts a further example embodiment of an electronic device 300 comprising the apparatus 100 of FIG. 1. The apparatus 100 can be provided as a module for device 300, or even as a processor/memory for the device 300 or a processor/memory for a module for such a device 300. The device 300 comprises a processor 308 and a storage medium 307, which are connected (e.g. electrically and/or wirelessly) by a data bus 380. This data bus 380 can provide an active coupling between the processor 308 and the storage medium 307 to allow the processor 308 to access the computer program code. It will be appreciated that the components (e.g. memory, processor) of the device/apparatus may be linked via cloud computing architecture. For example, the storage device may be a remote server accessed via the internet by the processor.

The apparatus 100 in FIG. 3 is connected (e.g. electrically and/or wirelessly) to an input/output interface 370 that receives the output from the apparatus 100 and transmits this to the device 300 via data bus 380. Interface 370 can be connected via the data bus 380 to a display 304 (touch-sensitive or otherwise) that provides information from the apparatus 100 to a user. Display 304 can be part of the device 300 or can be separate. The device 300 also comprises a processor 308 configured for general control of the apparatus 100 as well as the device 300 by providing signalling to, and receiving signalling from, other device components to manage their operation.

The storage medium 307 is configured to store computer code configured to perform, control or enable the operation of the apparatus 100. The storage medium 307 may be configured to store settings for the other device components. The processor 308 may access the storage medium 307 to retrieve the component settings in order to manage the operation of the other device components. The storage medium 307 may be a temporary storage medium such as a volatile random access memory. The storage medium 307 may also be a permanent storage medium such as a hard disk drive, a flash memory, a remote server (such as cloud storage) or a non-volatile random access memory. The storage medium 307 could be composed of different combinations of the same or different memory types.

Certain disclosed embodiments discussed herein may relate to portable electronic devices, for example so-called hand-portable electronic devices which may be hand-held in use (although they may be placed in a cradle in use). Such hand-portable electronic devices include so-called Personal Digital Assistants (PDAs), mobile telephones, smartphones and other smart devices, and tablet PCs.

The portable electronic devices/apparatus according to one or more disclosed embodiments may provide one or more audio/text/video communication functions (e.g. tele-communication, video-communication, and/or text transmission (Short Message Service (SMS)/Multimedia Message Service (MMS)/e-mailing) functions), interactive/non-interactive viewing functions (e.g. web-browsing, navigation, TV/program viewing functions), music recording/playing functions (e.g. MP3 or other format and/or (FM/AM) radio broadcast recording/playing), downloading/sending of data functions, image capture functions (e.g. using a (e.g. in-built) digital camera), and gaming functions.

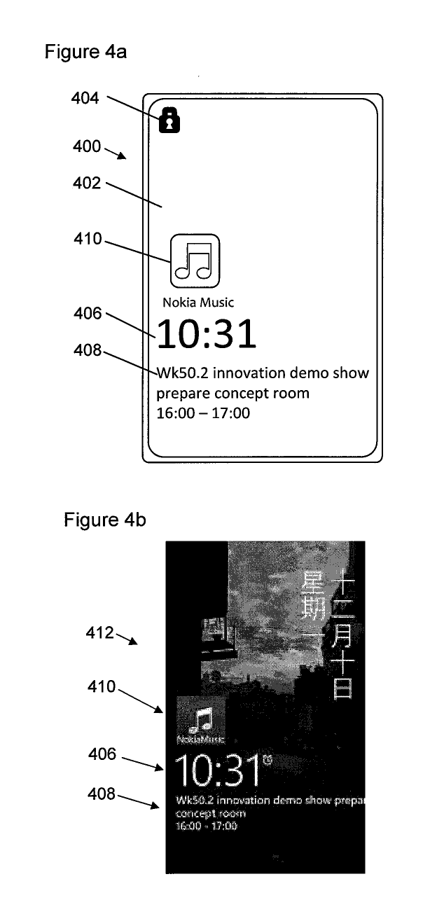

FIGS. 4a-4b illustrate an example embodiment of an apparatus/device 400 comprising a display screen 402 in use. The display screen 402 is displaying a locked symbol 404 to indicate that the apparatus/device 400 is currently locked. FIGS. 4a-4b show a locked screen of the display 402 of the apparatus/electronic device 400 operating in a locked mode. In this example operating in a locked mode means certain limited functionality is available, namely activating applications available from the locked screen. Unlocking the device is required in order to access further functionality of the apparatus/device 400. The display screen 402 is displaying the current time 406 and an upcoming calendar entry 408 as background information.

The display screen 402 of the apparatus/device 400 is also displaying an icon 410 (a graphical user interface element) for a music application. In this example the music application 410 can be used to download music for free for 365 days after the application 410 is made available to the user. Thus, the time-dependent functionality of the application 410 is that free music download functionality is available for a predetermined period of time of 365 days from the time at which the particular application 410 was made available for use. The application may be made available for use by, for example, an initial activation of the apparatus/device 400 or by downloading the application 410. The time-dependent functionality of free music downloads of the application 410 is currently available to a user, which is why an icon for the application 410 is displayed for use by a user on the locked screen of the apparatus/device 400.

The apparatus/device 400 may be said to provide one or more applications 410 in an application set for user activation. The inclusion of the one or more applications 410 in the application set is based on time-dependent functionality of the one or more applications 410. The apparatus is also configured to display a graphical user interface element 410 representing the at least one application in the application set on a display 402. In this example there is one application 410 in the application set with time-dependent functionality. If, for example, there was another application with time-dependent functionality, the application set would include both applications and an icon for that second application may also be displayed on the locked screen.

Without limiting the scope of the claims, one advantage may be that a user can readily gain access to the application 410 by a user interaction (such as touching the icon 410) in the locked screen. The user need not unlock the device nor, for example, navigate a menu system, to access the application. In a further example, the user may initiate the opening of the application from the lock screen and the apparatus may then prompt the user to unlock the device before directly opening the application for use (i.e. after the device is successfully unlocked, automatically continuing to open the selected application). Thereby the apparatus/device 400 allows easier user access to the application 410 which may be of greater interest to the user for the period in which the time-limited functionality is available. In certain examples, the user may be able to display icons for time-limited applications in the application set by performing a particular user gesture, such as shaking, squeezing/bending, tapping, or reciting a particular voice command to the apparatus/device, for example.

Another advantage may be that the user is presented with a visual prompt in the form of a selectable icon 410 for the application with time-limited functionality. The apparatus/device 400 allows for this to happen by assigning the application 410 to a set of applications with time-limited functionality. By automatically detecting that time-limited functionality is available and presenting those applications in the set for ready access and use to the user, the apparatus/device 400 can help the user to see that the particular application 410 provides certain features/functionality for a limited period. Thus the user can choose to use the application 410 during the period that those features/functionality is available and make the most of the application 410. Another advantage may be gained by the application provider, by allowing/hinting to a user to try out certain features which, for example, the user may need to pay for after a time-limited trial period of use.

If, for example, applications with time-limited functionality were not treated differently and assigned to be part of a set of such applications, then a user may not be aware that there is any time-limited functionality available and may miss using those features/functionality which are available for a predefined time period. This could be annoying for a user who may feel they have missed an opportunity to try out certain features or make the most of an application.

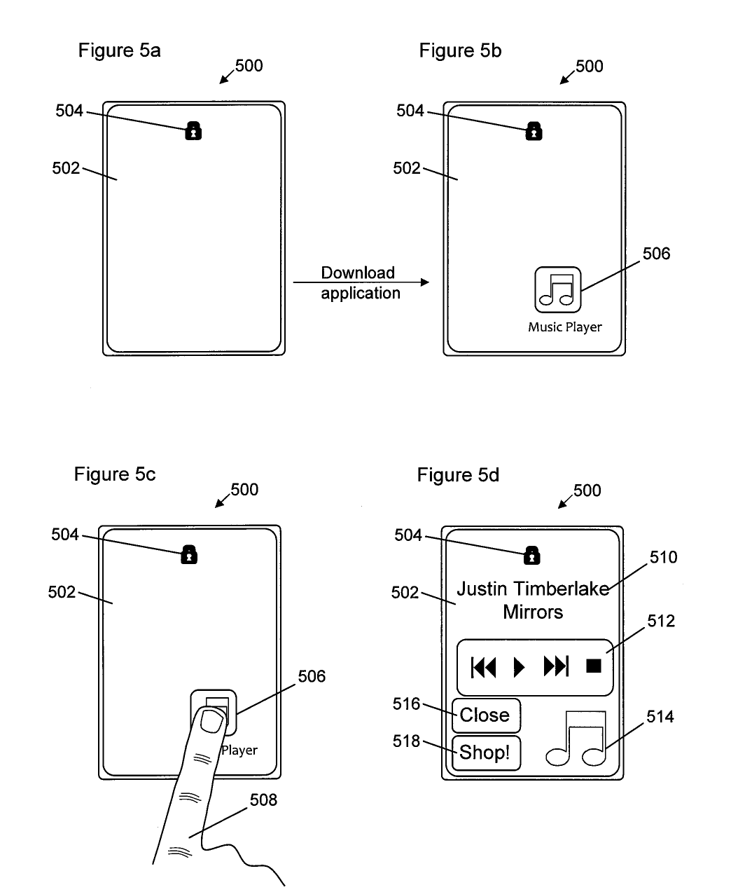

FIGS. 5a-5d illustrate an example embodiment of an apparatus/device 500 with a display screen 502 in use. The device may be locked as discussed above, as indicated by the locked symbol 504. In FIG. 5a, there are no applications in the set of applications having time-limited functionality. Therefore no applications icons are displayed on the screen 502. In this example applications having time-limited functionality may have icons associated with those applications displayed on the locked screen. Of course in some examples other icons and graphical user interface elements may be displayed on the locked screen, such as background information as in FIGS. 4a-4b, an unlock control/slider, and/or icons/graphical user interface elements particularly selected by a user for display on the locked screen, for example.

Between FIGS. 5a and 5b the user has downloaded (or otherwise installed) a music player application having time-limited functionality (for example, allowing free downloads for a predefined period after installation, or providing suggestions for music based on the current season, such as highlighting the availability of Christmas-themed songs in December). The apparatus/device 500 has determined that the application has time-dependent functionality and it has added the downloaded/installed application to an application set for user activation. In this example the inclusion of the application in the application set causes the apparatus/device to present a user-selectable icon 506 for opening the music player application on a locked screen 504 of the apparatus/device 500. The inclusion of the music application in the application set is based on time-dependent functionality of the application as discussed above.

In FIG. 5c, the user 508 selects the music application icon 506 by touching it, while the apparatus/device 500 is in the locked mode as indicated 504. Thus the apparatus/device 500 is configured to, based on a received user input 508 associated with the displayed graphical user interface element 506 of the particular application in the application set, launch the particular application as shown in FIG. 5d.

In FIG. 5d, the music player has been opened while the device remains in the locked mode as indicated 504. The user is able to use the application to, for example, listen to songs. The display 502 in FIG. 5d shows the name of the artist and song currently playing 510; some controls for playing music: rewind, play, fast forward and stop 512; a “close” button 516 to allow the user to close the application, a “shop” icon 518 allows the user to go to the online music store and download music, and an image 514 related to the music player application is displayed. In this example, further controls and options may be displayed to the user when the apparatus/device 500 is operating in an unlocked mode. In some examples, the application may provide the same functionality whether the apparatus/device 500 is operating in the locked mode or the unlocked mode. Alternatively, the user may initiate the opening of an application in the locked mode, which is completed once the user successfully unlocks the apparatus/device following a user prompt.

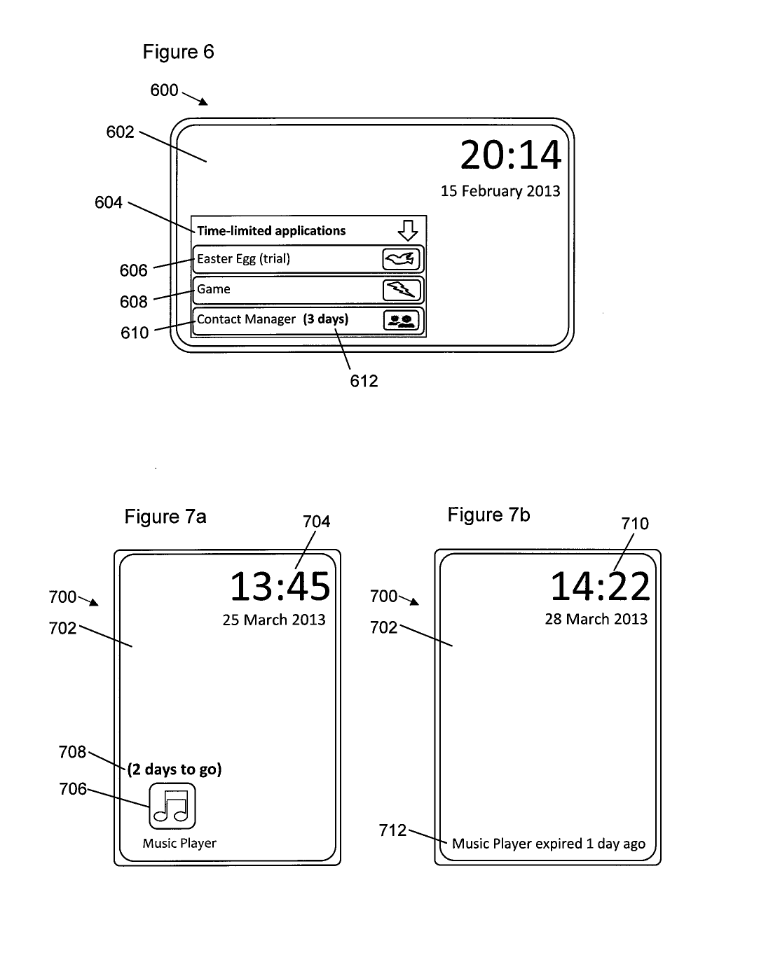

FIG. 6 illustrates an example embodiment of an apparatus/device 600 with a display screen 602 in use. In this example, the display 602 is currently showing a homescreen of the apparatus/device 600 and a pop-up menu 604.

The pop-up menu 604 in this example has three selectable options 606, 608, 610 each associated with a particular application having time-limited functionality. The apparatus/device 600 is configured to provide these applications in an application set for user activation. Thus a user is able to select one of the applications 606, 608, 610 in the menu 604 to open the application. The inclusion of the applications 606, 608, 610 in the application set is based on time-dependent functionality of the applications 606, 608, 610, and the set of applications is presented to a user in the pop-up menu 604. Of course, in some examples the set of applications may be presented to a user as a grid of tiles/icons, a banner displayed at an edge of the display 602, a particular highlighting being applied to icons relating to applications in the set, or otherwise.

In this example, one application 606 is a game which is a trial version available to be played for 30 days from download, after which the user needs to buy a full version of the game. Another application 608 is a game which provides seasonal additional functionality in the form of extra features available to the player (e.g., different levels and different characters available to play). Another application 610 is a productivity application allowing a user to manage his/her contact list for a free trial period of three months before the user is required to purchase the application to continue using the full functionality of the application 610. In this example, the productivity application 610 is displayed alongside a message 612 indicating how long (“3 days”) the user has available for using the application 610 before being required to purchase the full version. Thus the apparatus in this example is configured to provide an indication 612 of the remaining time available for use of the time-dependent functionality of a particular application 610 in the application set 606, 608, 610. In this example the time remaining is displayed for one application 610 in the set, but in certain examples the time remaining may be shown for all or other applications in the set.

The applications 606, 610 provide particular functionality for a limited period available for a predetermined period of time from the time at which the particular application was made available for use. In this example, one application 606 provides functionality for 30 days from downloading the application, and another application 610 provides full functionality for three months from download before providing a limited version unless the user pays for full functionality. The game application 608 provides functionality for predetermined periods of time between predetermined start and end times as seasonal extra features for the game.

FIGS. 7a-7b illustrate an example embodiment of an apparatus/device 700 with a display screen 702 in use. In this example, the display 702 is currently showing a main homescreen with background information on the current time and date 704, 710, as well as an icon associated with a Music Player application 706 having time-limited functionality. The main homescreen may be considered to be the default displayed homescreen, and/or the homescreen which is most often presented to the user.

In FIG. 7a, the current date is 25 Mar. 2013 704, and the time remaining of availability of the time-limited functionality 708 of the Music Player application 706 is indicated as “2 days to go” on the main homescreen.

In FIG. 7b, the current date is three days later and is 28 Mar. 2013 710. The time-limited functionality of the application 706 has expired. In this example the apparatus/device 700 is configured to provide for the removal of a displayed graphical user interface element (the icon 706) associated with the particular Music Player application from the display 702 of the apparatus/electronic device 700. In this example the display 702 is a main homescreen of the apparatus/device 700, but in certain examples may be a locked screen of the apparatus/electronic device 700 operating in a locked mode.

FIG. 7b also shows a message 712 stating “Music Player expired 1 day ago”. Thus a user can easily see why the Music Player icon is not presented. In some examples such a message may not be presented and upon expiry of time-limited functionality of an application an icon or other graphical user interface element associated with the application may simply be removed from display. The Music Player icon, or another graphical user interface element associated with the Music Player application, may be displayed elsewhere, such as on another display screen or in an application menu list. Because the time-limited functionality has expired, the icon 706 is no longer presented on the main homescreen.

Thus in this example the apparatus/device 700 is configured to provide one or more applications 706 in an application set for user activation, wherein the inclusion of the one or more applications 706 in the application set is based on time-dependent functionality of the one or more applications 706. Based on the expiry of time-dependent functionality of the particular application, the application 706 has been removed from the application set and in this example is no longer displayed on the main homescreen.

The user may be able to select the message 712 and an online marketplace/purchasing screen may be displayed allowing the user to purchase the application 706 or the expired time-limited functionality of the application if he or she wishes, to re-obtain the functionality which was available as time-limited functionality but which has now expired. Such a message 712 may be displayed for a predetermined amount of time after expiry of the time-limited functionality, for example for a week or a month after expiry.

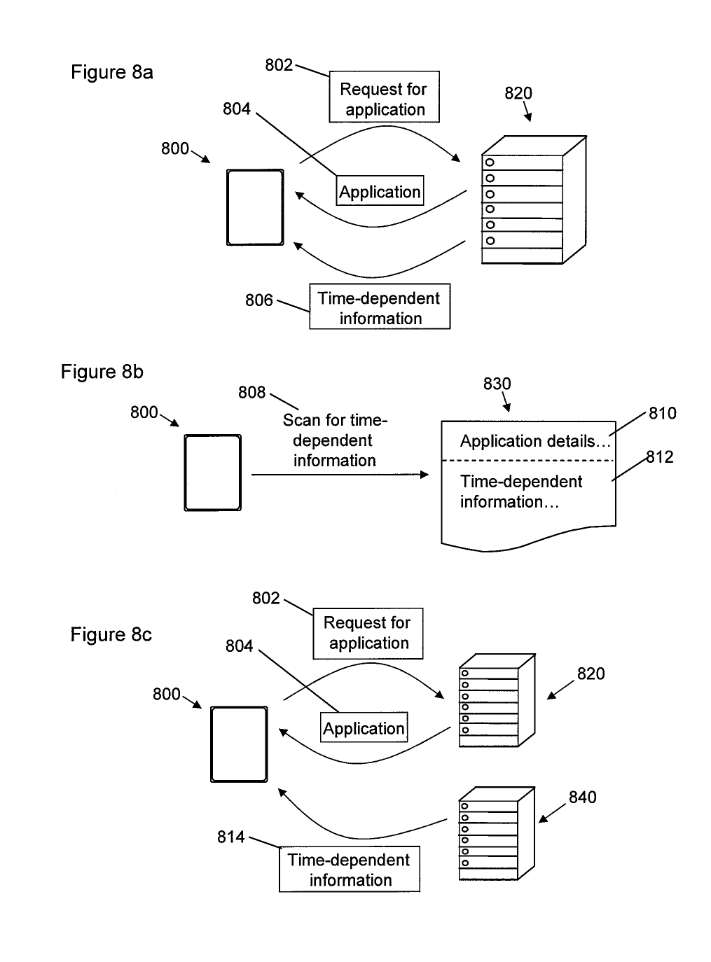

FIGS. 8a-8c illustrate an apparatus/device 800 obtaining information about time-dependent functionality of an application according to embodiments of the present disclosure.

FIG. 8a shows an apparatus/device 800 and a remote server 820. The apparatus/device 800 requests an application 802 having time-limited functionality from the server 820. The server 820 provides the requested application 804 to the apparatus/device 800. In this example, the server 820 also provides information about the time-limited functionality 806 of the requested application 804 to the apparatus/device 800, so that the apparatus/device is actively informed that the application 804 has such time-limited functionality. The time-dependent information may be provided as part of the particular application 804. The apparatus/device 800 may therefore add the application 804 to an application set for user activation based on the time-dependent functionality of the application 804 which was provided to the apparatus/device by the application.

FIG. 8b shows an apparatus/device 800 which has already received an application having time-limited functionality. The apparatus/device 800 in this example is configured to determine that the particular application has time-dependent functionality. In this example the apparatus/device 800 scans the application to look for information 830 about time-limited functionality. The information 830 scanned by the apparatus/device may include application details 810 (such as executable code and images) and time-dependent information 812 if present, for example. Other information may be provided in certain examples. The apparatus/device 800 may therefore provide the application 804 in an application set for user activation based on the time-dependent functionality of the application 804 which the apparatus/device 800 has identified.

FIG. 8c shows an apparatus/device 800 and two remote servers 820, 840. The apparatus/device 800 requests an application 802 having time-limited functionality from the server 820. The server 820 provides the requested application 804 to the apparatus/device 800. In this example, the third party server 840 provides information about the time-limited functionality 814 of the requested application 804 to the apparatus/device 800, so that the apparatus/device is actively informed that the application 804 has such time-limited functionality. The third party server 840 may be provided with information from the server 820 and/or the apparatus/device 800 that the application has been provided to the apparatus/device 800, thereby initiating the provision of the time-limited information to the apparatus/device 800. The apparatus/device 800 may therefore provide the application 804 in an application set for user activation based on the time-dependent functionality of the application 804 which was provided to the apparatus/device by the third party server 840.

The apparatus/device 800 may also determine when an application should be removed from the application set and therefore no longer displayed to a user for actuation. Information relating to the expiry of the time-limited functionality may be included in the time-dependent information 806, 814 or it may be provided in a separate communication from the server 820 or 840. For example, the apparatus/device may determine that time-dependent functionality is available and maintain the particular application in the application set until it is informed otherwise by server 820 or 840. The apparatus may determine the expiry of the time-limited functionality during its scan 808 of the application, or it may scan the applications at predetermined intervals to see if the time-limited functionality is still available. The apparatus may then remove an application from the application set if it is determined that the time-dependent functionality has expired/ended.

The above examples may be considered to demonstrate that the apparatus/device 800 may be configured to provide for the identification of the at least one application 804 for inclusion in the application set, and/or to provide for the identification of at least one application in the application set for removal from the application set upon expiry of the time-dependent functionality of the application.

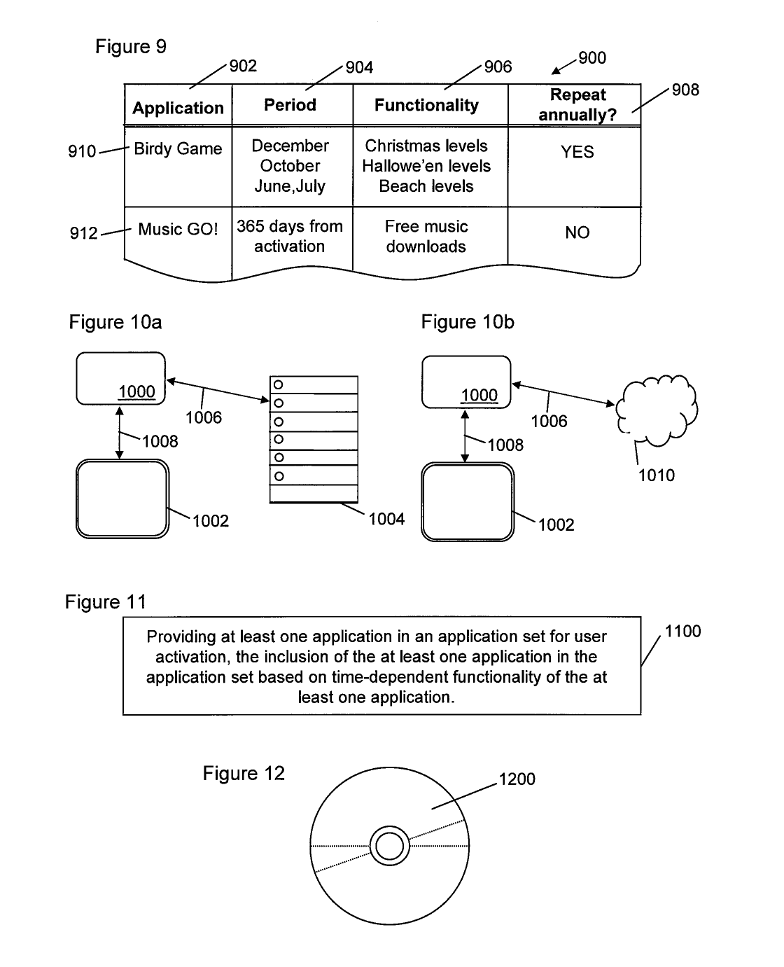

FIG. 9 shows an example list 900 of information relating to applications having time-limited functionality in the application set. An apparatus/device as described herein is configured in this example to provide applications in the application set for user activation by storing a list 900 of the applications in the set. This example shows two applications 910, 912 in the application set. The list 900 in this example provides information about the name of the application 902, the period of time in which time-limited functionality is available 904, the functionality available in that time-limited period 906, and whether the time-limited functionality period is a single occurrence or is repeated each year 908. Therefore for the “Birdy Game” application, special Christmas levels are available to play in December each year, special Hallowe'en levels are available to play in October each year, and special Beach levels are available to play in June and July each year. For the “Music GO!” application, one 365 day time period is available from activation of the application providing free music downloads. Of course, other information and other applications may be given in such a list 900.

A predetermined period of time which runs from a user-determined time point (such as from the time of download of the application or from the time of activation of the application) may be based on the local time. For example, a user may download an application to his device at 8:00 am on Monday while in Beijing. The predetermined time period for the functionality starts at 8:00 am Beijing time. The application may provide time-dependent functionality for a period of seven days from download. If the user then travels to London (thereby changing the local time displayed on his device), the time-dependent functionality will end at 8:00 am Beijing time on the Monday following download, even though the user's device is running on London local time.

FIG. 10a shows an example of an apparatus 1000 in communication with a remote server. FIG. 10b shows an example of an apparatus 1000 in communication with a “cloud” for cloud computing. In FIGS. 10a and 10b, apparatus 1000 (which may be apparatus 100, 200 or 300) is also in communication with a further apparatus 1002. The apparatus 1002 may be a touch screen display or camera for example. In some examples, the apparatus 1000 and further apparatus 1002 may both be comprised within a device such as a portable communications device or PDA. Communication may be via a communications unit, for example.

FIG. 10a shows the remote computing element to be a remote server 1004, with which the apparatus 1000 may be in wired or wireless communication (e.g. via the internet, Bluetooth, NFC, a USB connection, or any other suitable connection as known to one skilled in the art). In FIG. 10b, the apparatus 1000 is in communication with a remote cloud 1010 (which may, for example, be the Internet, or a system of remote computers configured for cloud computing). For example, the apparatus 1000 may have access to an application with time-limited functionality stored on the remote server 1004 or cloud 1010, or may download such an application from the server 1004 or cloud 1010. As another example, the apparatus 1000 may create, modify and/or maintain a list of time-limited applications and the list may be stored remotely 1004, 1010. In some examples the second apparatus may also be in direct communication with the remote server 1004 or cloud 1010.

FIG. 11 illustrates a method 1100 according to an example embodiment of the present disclosure. The method comprises providing at least one application in an application set for user activation, the inclusion of the at least one application in the application set based on time-dependent functionality of the at least one application.

FIG. 12 illustrates schematically a computer/processor readable medium 1000 providing a program according to an embodiment. In this example, the computer/processor readable medium is a disc such as a Digital Versatile Disc (DVD), Blu-ray or a compact disc (CD). In some embodiments, the computer readable medium may be any medium that has been programmed in such a way as to carry out the functionality herein described. The computer program code may be distributed between the multiple memories of the same type, and/or multiple memories of a different type, such as ROM, RAM, flash, hard disk, solid state, etc.

Any mentioned apparatus/device/server and/or other features of particular mentioned apparatus/device/server may be provided by apparatus arranged such that they become configured to carry out the desired operations when enabled, e.g. switched on, or the like. In such cases, they may not necessarily have the appropriate software loaded into the active memory in the non-enabled (e.g. switched off state) and load the appropriate software in the enabled (e.g. on state). The apparatus may comprise hardware circuitry and/or firmware. The apparatus may comprise software loaded onto memory. Such software/computer programs may be recorded on the same memory/processor/functional units and/or on one or more memories/processors/functional units.

In some embodiments, a particular mentioned apparatus/device/server may be pre-programmed with the appropriate software to carry out desired operations, and wherein the appropriate software can be enabled for use by a user downloading a “key”, for example, to unlock/enable the software and its associated functionality. Advantages associated with such embodiments can include a reduced requirement to download data when further functionality is required for a device, and this can be useful in examples where a device is perceived to have sufficient capacity to store such pre-programmed software for functionality that may not be enabled by a user.

Any mentioned apparatus/circuitry/elements/processor may have other functions in addition to the mentioned functions, and that these functions may be performed by the same apparatus/circuitry/elements/processor. One or more disclosed aspects may encompass the electronic distribution of associated computer programs and computer programs (which may be source/transport encoded) recorded on an appropriate carrier (e.g. memory, signal).

Any “computer” described herein can comprise a collection of one or more individual processors/processing elements that may or may not be located on the same circuit board, or the same region/position of a circuit board or even the same device. In some embodiments one or more of any mentioned processors may be distributed over a plurality of devices. The same or different processor/processing elements may perform one or more functions described herein.

The term “signalling” may refer to one or more signals transmitted as a series of transmitted and/or received electrical/optical signals. The series of signals may comprise one, two, three, four or even more individual signal components or distinct signals to make up said signalling. Some or all of these individual signals may be transmitted/received by wireless or wired communication simultaneously, in sequence, and/or such that they temporally overlap one another.

With reference to any discussion of any mentioned computer and/or processor and memory (e.g. including ROM, CD-ROM etc), these may comprise a computer processor, Application Specific Integrated Circuit (ASIC), field-programmable gate array (FPGA), and/or other hardware components that have been programmed in such a way to carry out the inventive function.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the disclosure.

While there have been shown and described and pointed out fundamental novel features as applied to example embodiments thereof, it will be understood that various omissions and substitutions and changes in the form and details of the devices and methods described may be made by those skilled in the art without departing from the scope of the disclosure. For example, it is expressly intended that all combinations of those elements and/or method steps which perform substantially the same function in substantially the same way to achieve the same results are within the scope of the disclosure. Moreover, it should be recognized that structures and/or elements and/or method steps shown and/or described in connection with any disclosed form or embodiments may be incorporated in any other disclosed or described or suggested form or embodiment as a general matter of design choice. Furthermore, in the claims means-plus-function clauses are intended to cover the structures described herein as performing the recited function and not be limited to structural equivalents, but also include equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1. An apparatus comprising:
at least one processor; and
at least one memory including computer program code,
the at least one memory and the computer program code configured to, with the at least one processor, cause the apparatus to perform at least the following:
provide at least one application in an application set for user activation, the inclusion of the at least one application in the application set based on time-dependent functionality of the at least one application.

2. The apparatus of claim 1, wherein the apparatus is configured to provide for the automatic identification of the at least one application having time-dependent functionality for inclusion in the application set.

3. The apparatus of claim 1, wherein the apparatus is configured to differentiate between applications having time-dependent functionality which are included in the application set, and applications that do not have time dependent functionality which are outside the application set.

4. The apparatus of claim 1, wherein the apparatus is configured to display a graphical user interface element representing a particular application in the application set on a display.

5. The apparatus of claim 4, wherein the apparatus is configured to display the graphical user interface element in a locked screen of a display of an electronic device, the electronic device operating in a locked mode.

6. The apparatus of claim 4, wherein the apparatus is configured to, based on a received user input associated with the displayed graphical user interface element of a particular application in the application set, launch the particular application.

7. The apparatus of claim 1, wherein the time-dependent functionality of the at least one application is one or more of:
particular functionality of a particular application in the application set available for a predetermined period of time from the time at which the particular application was made available for use;
particular functionality of a particular application in the application set available for a predetermined period of time from the time at which that particular functionality was made available for use; and
particular functionality of a particular application available for a predetermined period of time between predetermined start and end times.

8. The apparatus of claim 1, wherein the apparatus is configured to provide for the inclusion of a particular application in the application set based on currently available time-dependent functionality of the particular application.

9. The apparatus of claim 1, wherein the apparatus is configured to provide for the removal of a particular application from the application set based on the expiry of time-dependent functionality of the particular application.

10. The apparatus of claim 9, wherein the apparatus is configured to provide for the removal of a displayed graphical user interface element associated with the particular application removed from the application set from a display of an electronic device.

11. The apparatus of claim 1, wherein the apparatus is configured to provide one or more applications in the application set for user activation by storing a list of the one or more applications.

12. The apparatus of claim 1, wherein the apparatus is configured to provide for the inclusion of a particular application in the application set based on one or more of:
the apparatus receiving information from the particular application that the particular application has time-dependent functionality;
the apparatus determining that the particular application has time-dependent functionality; and
the apparatus receiving information from a third party that the particular application has time-dependent functionality.

13. The apparatus of claim 1, wherein the apparatus is configured to provide an indication of the remaining time available for use of the time-dependent functionality of a particular application in the application set.

14. The apparatus of claim 1, wherein the apparatus is configured such that the application set is a time-dependent application set which is limited to include applications having time-dependent functionality.

15. The apparatus of claim 1, wherein the apparatus is one or more of: a portable electronic device, a mobile phone, a smartphone, a tablet computer, a surface computer, a laptop computer, a personal digital assistant, a graphics tablet, a pen-based computer, a digital camera, a watch, a non-portable electronic device, a desktop computer, a monitor/display, a household appliance, a refrigerator, a cooker, a cooling/heating system, a server, or a module for one or more of the same.

16. A non-transitory computer readable medium comprising computer program code stored thereon, the computer readable medium and computer program code being configured to, when the program code is run on at least one processor cause an apparatus to perform at least the following:
provide at least one application in an application set for user activation, the inclusion of the at least one application in the application set based on time-dependent functionality of the at least one application.

17. A method comprising:
providing at least one application in an application set for user activation, the inclusion of the at least one application in the application set based on time-dependent functionality of the at least one application.
